(19) United States
(12) Patent Application Publication
(10) Pub. No.: US 2012/0249430 A1
(43) Pub. Date: Oct. 4, 2012

(54) Multi-Touch Screen Recognition of Interactive Objects, and Application Thereof

(76) Inventors: David Phillip OSTER, San Jose, CA (US); Julien Mercay, Belmont, CA (US)

(21) Appl. No.: 13/077,758

(22) Filed: Mar. 31, 2011

(51) Int. Cl. G06F 3/041

(52) U.S. Cl. 345/173

(57) ABSTRACT

Systems, methods and articles of manufacture for multi-touch screen recognition of interactive objects with contacts are described herein. Embodiments of the present disclosure relate to equipping a physical object with an asymmetrical pattern of contacts where the multi-touch device identifies the physical object being used to interact with the multi-touch device based on the asymmetrical pattern of contacts located on the physical object. The multi-touch device is also able to identify characteristics of the physical object based on the asymmetrical pattern of contacts as the user interacts with the multi-touch device. Each physical object has a different asymmetrical pattern of contacts so that multi-touch device identifies the differences between each physical object as user interacts with the multi-touch device.

### BACKGROUND

In a multi-touch device, a user has an ability to interact with applications by touching the multi-touch device with pointed objects such as the user's fingers or a pointer. As the application requires, the user moves the pointed object across the multi-touch device and presses down on the multi-touch device. The application responds accordingly to the pointed object's motions across the screen of the multi-touch device.

Multi-touch devices report the position of a pointed object as a single (x, y) coordinate on the multi-touch device. Multi-touch devices can also report the past (x, y) coordinate point representing the past position of the pointed object and the current (x, y) coordinate point representing the current position of the pointed object. With this capability, multi-touch devices track the movement of the pointed object across the multi-touch device. Applications then track the pointed object across the multi-touch device accordingly.

### BRIEF SUMMARY

Embodiments of the present disclosure relate to object recognition capabilities of multi-touch screen interface tools. In a first embodiment, a computer implemented method includes steps for tracking, on a multi-touch device, at least one interactive object having an asymmetrical pattern of contacts located on a surface of the interactive object. The contacts can be, for example bumps. A signal can be received when the interactive object interfaces with an interactive screen of the multi-touch device. The interactive object can be identified using the asymmetrical pattern of contacts located on the surface of the interactive object, where the asymmetrical pattern of contacts represents a pattern specific to the interactive object. The asymmetrical pattern of contacts can be examined to determine a state of the interactive object. The multi-touch device can be synchronized based on the state of the interactive object represented by the asymmetrical pattern of contacts.

In a second embodiment, a system provides a multi-touch device that tracks at least one interactive object having an asymmetrical pattern of contacts located on a surface of the interactive object. A receiver receives a signal when the interactive object interfaces with an interactive screen of the multi-touch device. An identifier identifies the interactive object using the asymmetrical pattern of contacts located on the surface of the interactive object, where the asymmetrical pattern of contacts represents a pattern specific to the interactive object. An analyzer examines the asymmetrical pattern of contacts to determine a state of the interactive object. A synchronizer synchronizes the multi-touch device to the interactive object based on the state of the interactive object represented by the asymmetrical pattern of contacts.

Further embodiments, features, and advantages, as well as the structure and operation of the various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers can indicate identical or functionally similar elements.

FIG. 1 illustrates example interactive objects on an example multi-touch device, according to an embodiment.

FIG. 2 illustrates an example interactive object according to an embodiment.

FIG. 3 illustrates an example interactive object with a central stamp according to an embodiment.

FIG. 4 illustrates an example multi-touch device computing system architecture, according to an embodiment.

FIG. 5 is a flowchart illustrating an example aspect of operation, according to an embodiment.

### DETAILED DESCRIPTION

A multi-touch device can provide a capability for a user to interact with the multi-touch device by using physical objects that are not limited to pointed objects. The multi-touch device recognizes the type of physical object being used along with the location of the physical object and the orientation of the physical object on the multi-touch device. In the Detailed Description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic may be described in connection with an embodiment, it may be within the knowledge of one skilled in the art to effect such feature, structure, or characteristic in connection with other embodiments whether or not explicitly described.

### Overview

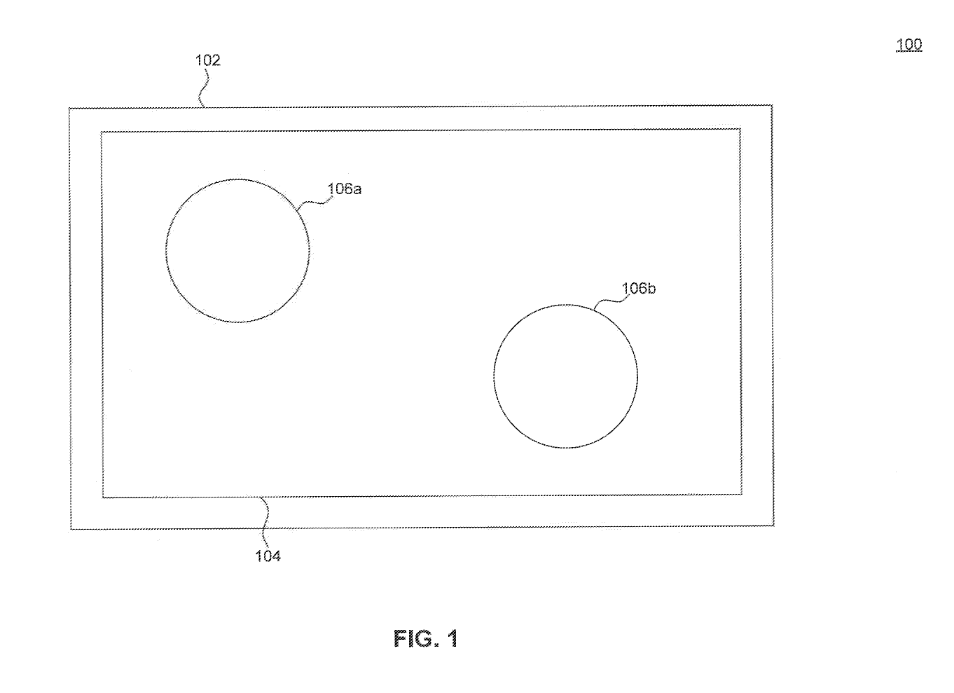

FIG. 1 depicts an example interactive system 100 in which embodiments of the present disclosure, or portions thereof, can be implemented. System 100 includes a multi-touch device 102 and one or more interactive objects 106. Multi-touch device 102 includes interactive screen 104. Examples of multi-touch device 102 can include but are not limited to a personal digital assistant, satellite navigation device, mobile phone, and video game console.

Generally, embodiments described herein use interactive object 106 to interact with multi-touch device 102. Interactive object 106 provides a user with a capability to interact with applications operating on multi-touch device 102. Interactive object 106 is a physical object with which the user wishes to interact with multi-touch device 102. Multi-touch device 102 includes an interactive screen 104. Interactive screen 104 interfaces with interactive object 106. As the user attempts to interact with multi-touch device 102, the user maneuvers interactive object 106 on interactive screen 104. Multi-touch device 102 receives a signal from interactive object 106 as interactive object 106 interfaces with interactive screen 104.

The signal received by multi-touch device 102 from interactive object 106 can be the result of a change in the capacitance of interactive screen 104. As interactive object 106 touches interactive screen 104, the capacitance at the location of the touch changes, triggering a change in voltage at that location on the interactive screen 104. Multi-touch device 102 registers the change in voltage as the location of interactive object 106 on interactive screen 104. Further description and examples regarding the interaction of interactive object 106 and multi-touch device 102 are provided below.

Example implementations of interactive object 106 can include but not limited to application navigation and interactive game pieces. An example structure of interactive object 106 can include but is not limited to a circular structure shaped like a checker piece used in the game of checkers, a peg structure shaped like a chess piece, or any other shaped structure that can be manipulated by a user. Interactive object 106 can be large enough so that a user can easily maneuver interactive object 106 across interactive screen 104. However, interactive object 106 can be small in relation to interactive screen 104 so that interactive object 106 can easily navigate through applications and serve as an interactive game piece without encompassing all of interactive screen 104. Interactive object 106 can be composed of a durable plastic material. Further description and examples regarding interactive object 106 are provided below.

Interactive screen 104 is an electronic visual display that can detect the presence and location of interactive object 106 within an active area. Interactive screen 104 enables a user to interact directly with what can be displayed on interactive screen 104 rather than indirectly with a cursor controlled by a mouse or touchpad. Multi-touch device 102 can include any device with interactive screen 104 running an application requiring interaction from a user with multi-touch device 102.

According to an embodiment, each interactive object 106a and 106b is equipped with a unique, asymmetrical pattern of contacts. The asymmetrical pattern of contacts can be located on a surface of interactive object 106 that interfaces with interactive screen 104. For example, each interactive object 106 can have a flat surface equipped with an asymmetrical pattern of contacts that enables the user to interact with multi-touch device 102. The asymmetrical pattern of contacts on each interactive object 106 also enables multi-touch device 102 to recognize an identity and an orientation of interactive object 106 coupled with tracking movement of interactive object 106 across interactive screen 104, as opposed to simply tracking the movement of a pointed object implemented by the user.

### Interactive Objects

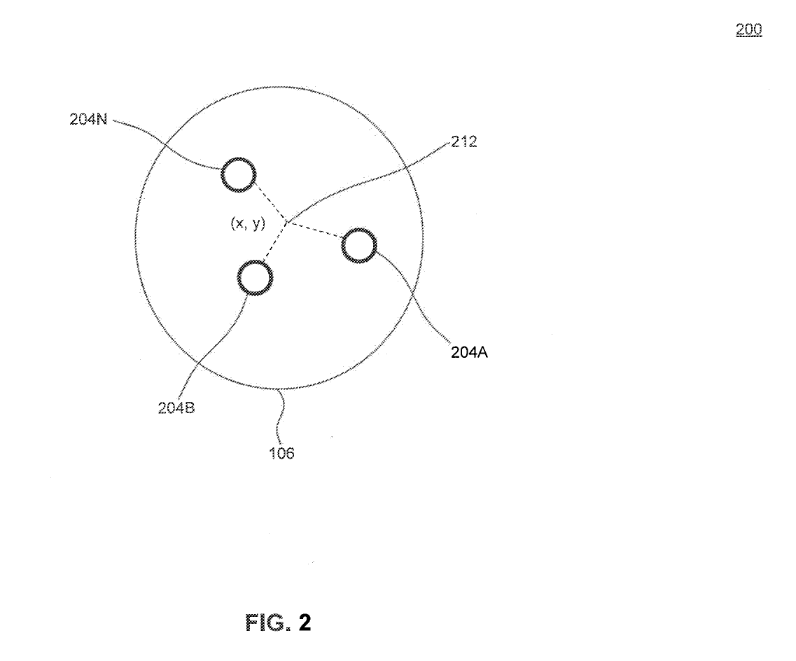

FIG. 2 depicts a more detailed view of a surface of interactive object 106 in which embodiments of the present disclosure, or portions thereof, can be implemented. The surface of interactive object 106 that touches interactive screen 104 includes an asymmetrical pattern of contacts 204 A-N. Centroid 212 can be calculated for interactive object 106 based on a positioning of asymmetrical pattern of contacts 204 A-N.

A user interacts with multi-touch device 102 by maneuvering interactive object 106 across interactive screen 104. When interactive screen 104 is a capacitive screen, for example, the contacts on the surface of interactive object 106 can be individual capacitive contacts. The contacts can be located on bumps on the surface of interactive object 106. Multi-touch device 102 receives a signal from interactive object 106 as interactive object 106 interfaces with interactive screen 104. Multi-touch device 102 recognizes interactive object 106 based on the asymmetrical pattern of contacts 204 A-N and tracks interactive object 106 as the user maneuvers interactive object 106 with respect to interactive screen 104. Such maneuvering can include rotational movement, translational movement, or a combination thereof.

In an embodiment, interactive object 106 is a physical object that a user can employ to interact with multi-touch device 102. In order for multi-touch device 102 to recognize interactive object 106, interactive object 106 includes asymmetrical pattern of contacts 204 A-N, where N can be any integer greater than 2. Asymmetrical pattern of contacts 204 A-N enables multi-touch device 102 to recognize a physical object such as interactive object 106 and does not limit the physical object to a pointed object such as a user's finger or a pointer. Asymmetrical pattern of contacts 204 A-N also enables multi-touch device 102 to track the physical location of interactive object 106 as user moves interactive object 106 across interactive screen 104 of multi-touch device 102. Asymmetrical pattern of contacts 204 A-N further enables multi-touch device 102 to identify which interactive object 106 the user is employing and the orientation of interactive object 106.

In an embodiment, the user places a surface of interactive object 106 having asymmetrical pattern of contacts 204 A-N onto multi-touch device 102, such that asymmetrical pattern of contacts 204 A-N are in contact with interactive screen 104. Multi-touch device 102 receives a signal as asymmetrical pattern, of contacts 204 A-N touches interactive screen 104.

Multi-touch device 102 identifies interactive object 106 by examining the signal(s) received from asymmetrical pattern of contacts 204 A-N. Asymmetrical pattern of contacts 204 A-N represents a unique pattern of contacts specific to interactive object 106. Multi-touch device 102 can include a database or table, for example, that maps various patterns of contacts to specific interactive objects for one or more applications. In this manner, multi-touch device 102 can recognize asymmetrical pattern of contacts 204 A-N as the unique pattern of contacts specific to interactive object 106. Based on this recognition, multi-touch device 102 identifies interactive object 106 as the physical object touching interactive screen 104.

In an embodiment, multi-touch device 102 differentiates interactive object 106 with asymmetrical pattern of contacts 204 A-N from a second interactive object with a second asymmetrical pattern of contacts. Asymmetrical pattern of contacts 204 A-N represents a unique pattern of contacts specific to interactive object 106. A second asymmetrical pattern of contacts different from asymmetrical pattern of contacts 204 A-N represents a second unique pattern of contacts specific to a second interactive object. Based on the differences in unique patterns, multi-touch device 102 differentiates between interactive object 106 and the second interactive object as each contact interacts with interactive screen 104 of multi-touch device 102.

For example, if a user wishes to play a game of chess on multi-touch device 102 against a second user, multi-touch device 102 identifies each chess piece that the user places on interactive screen 104. Each chess piece can have a different asymmetrical pattern of contacts. Multi-touch device 102 recognizes each chess piece based on the asymmetrical pattern of contacts for each piece. For example, interactive object 106 with asymmetrical pattern of contacts 204 A-N can be a king piece. Multi-touch device 102 recognizes interactive object 106 as the king piece because of asymmetrical pattern of contacts 204 A-N. A pawn piece can have a second asymmetrical pattern of contacts different from the king piece with asymmetrical pattern of contacts 204 A-N, Based on the second asymmetrical pattern of contacts, multi-touch device 102 recognizes the second interactive object as the pawn piece.

Multi-touch device 102 also examines asymmetrical pattern of contacts 204 A-N of interactive object 106 to determine a state of interactive object 106. As would be appreciated by one having skill in the relevant art(s) given the description herein, the state of interactive object 106 can include but is not limited to a location of interactive object 106 on multi-touch device 102, a movement of interactive object 106 relative to multi-touch device 102, an orientation of interactive object 106 relative to multi-touch device 102, and a velocity of interactive object 106 relative to multi-touch device 102.

In an embodiment, multi-touch device 102 identifies a location of interactive object 106 by identifying where asymmetrical pattern of contacts 204 A-N is touching interactive screen 104. In some examples, multi-touch device 102 identifies a location of interactive object 106 by identifying the location of centroid 212 relative to each contact 204 A-N.

In an embodiment, multi-touch device 102 tracks interactive object 106 on interactive screen 104 using asymmetrical pattern of contacts 204 A-N. As long as asymmetrical pattern of contacts 204 A-N remains in contact with interactive screen 104, multi-touch device 102 is capable of tracking the movement of interactive object 106 on interactive screen 104.

In an embodiment, multi-touch device 102 recognizes the orientation of interactive object 106 on interactive screen 104 based on asymmetrical pattern of contacts 204 A-N. The orientation of interactive object 106 can directly correspond to the orientation of asymmetrical pattern of contacts 204 A-N with respect to interactive screen 104. The orientation of interactive object 106 can include but is not limited to the direction interactive object 106 can be facing. As the orientation of interactive object 106 changes, so does the orientation of asymmetrical pattern of contacts 204 A-N. Multi-touch device 102 recognizes the change in orientation of interactive object 106 based on the change in orientation of asymmetical pattern of contacts 204 A-N in contact with interactive screen 104.

in an embodiment, multi-touch device 102 recognizes the identity of interactive object 106 based on asymmetrical pattern of contacts 204 A-N and displays a symbol on interactive screen 104 representing the identity of interactive object 106. The symbol displayed on interactive screen 104 corresponds to the state of interactive object 106 touching interactive screen 104. As interactive object 106 moves across interactive screen 104 of multi-touch device 102, the symbol representing interactive object 106 displayed on interactive screen 104 of multi-touch device 102 moves with interactive object 106. The orientation of the symbol also changes with interactive object 106. For example, if interactive object 106 were to change direction on interactive screen 104 of multi-touch device 102, then the symbol displayed on interactive screen 104 would also change direction.

For example, the user can interact with multi-touch device 102 and participate in a military themed game. The user can wish to change the orientation of a cannon displayed on multi-touch device 102. That is, the user can wish to maneuver the cannon so that the cannon turns and faces a different direction and target. In this example, multi-touch device 102 recognizes interactive object 106 having asymmetrical pattern of contacts 204 A-N as the cannon. As the user turns interactive object 106, multi-touch device 102 recognizes the turning of asymmetrical pattern of contacts 204 A-N so that a cannon image that can be displayed on multi-touch device 102 also turns corresponding to the movement of interactive object 106.

In another example, if a user wishes to play a game of chess on multi-touch device 102 against a second user, multi-touch device 102 identities each chess piece the user places on interactive screen 104 of multi-touch device 102. Multi-touch device 102 recognizes each chess piece based on the asymmetrical pattern of contacts for each piece and displays a symbol for each respective piece on interactive screen 104. For example, interactive object 106 with asymmetrical pattern of contacts 204 A-N can be a king piece. Multi-touch device 102 recognizes interactive object 106 as the king piece because of asymmetrical pattern of contacts 204 A-N and displays a symbol representing a king piece on interactive screen 104. As the user moves and changes the orientation of the king piece, asymmetrical pattern of contacts 204 A-N also moves and changes orientation. The symbol representing the king piece on interactive screen 104 then also moves and changes orientation accordingly.

In an embodiment, multi-touch device 102 also executes an operation based on a motion of interactive object 106 on interactive screen 104 of multi-touch device 102. For example, the user can compress a selector of interactive object 106 onto interactive screen 104 of multi-touch device 102 to make a selection, so that multi-touch device 102 executes an operation based on the selection.

In an embodiment, each motion the user executes with interactive object 106 on interactive screen 104 corresponds to a different operation executed by multi-touch device 102. For example, the user can slide interactive object 106 across interactive screen 104 to execute a first operation by multi-touch device 102. User can also twist interactive object 106 on interactive screen 104 to execute a second operation by multi-touch device 102. Different motions of interactive object 106 can include but are not limited to compressing, twisting, and sliding.

In an embodiment, multi-touch device 102 identifies interactive object 106, recognizes the location of interactive object 106, tracks interactive object 106, and recognizes the orientation of interactive object 106 by calculating a centroid 212 for interactive object 106. Multi-touch device 102 calculates centroid 212 based on asymmetrical pattern of contacts 204 A-N. As would be appreciated by one having skill in the relevant art(s) given the description herein, centroid 212 can be a geometric center of a plane figure, defined by the intersection of all straight lines that divide the plane figure into two parts of equal moment. Centroid 212 can also be observed as the average of all points of the plane figure.

An arrangement of asymmetrical pattern of contacts 204 A-N generates centroid 212 for that arrangement of asymmetrical pattern of contacts 204 A-N. Varying the arrangement of asymmetrical pattern of contacts 204 A-N also varies the geometric center of the asymmetrical pattern of contacts 204 A-N in relation to each contact. This in turn causes centroid 212 to vary between two different asymmetrical patterns of contacts.

For example, interactive object 106 with asymmetrical pattern of contacts 204 A-N can be a king piece for a chess game. Multi-touch device 102 calculates centroid 212 for interactive object 106 based on the arrangement of asymmetrical pattern of contacts 204 A-N. Multi-touch device 102 recognizes interactive object 106 as the king piece based on the location of centroid 212 relative to asymmetrical pattern of contacts 204 A-N. A pawn piece has a second arrangement for a second asymmetrical pattern of contacts different from the king piece with asymmetrical pattern of contacts 204 A-N. Based on the second arrangement of the second asymmetrical pattern of contacts, multi-touch device 102 calculates a second centroid for the second interactive object. Multi-touch device 102 recognizes the second interactive object as the pawn piece and not the king piece because the location of the second centroid relative to the second set of contacts on the pawn piece differs from that of the king piece.

In an embodiment, multi-touch device 102 calculates a coordinate on interactive screen 104 based on the location of centroid 212. As centroid 212 changes position and orientation on interactive screen 104 of multi-touch device 102, multi-touch device 102 recalculates the coordinate located on interactive screen 104.

### Applications of the Interactive Object

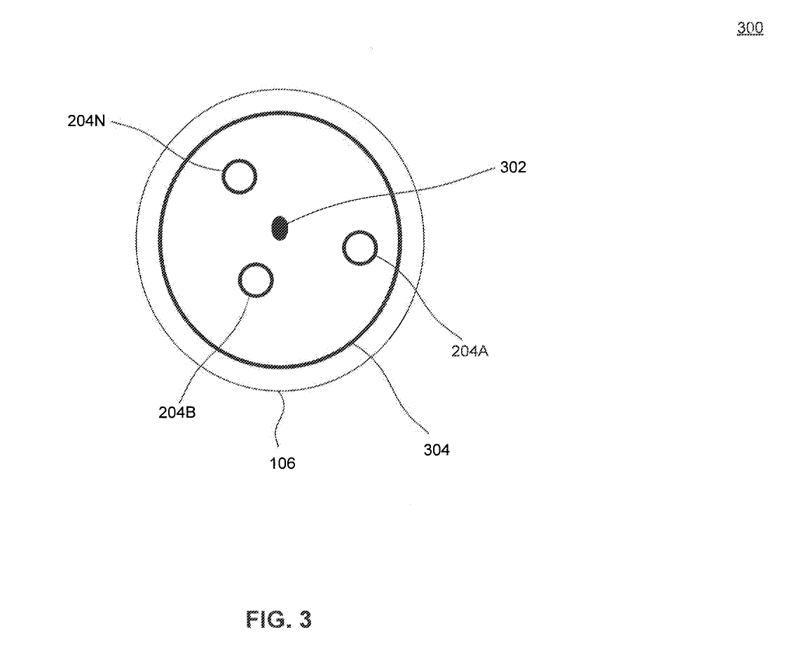

FIG. 3 depicts a more detailed view of interactive object 106 in which embodiments of the present disclosure, or portions thereof, can be implemented. Interactive object 106 includes an asymmetrical pattern of contacts 204 A-N, a central stamp 302, and a ring 304.

The user interacts with multi-touch device 102 by maneuvering interactive object 106 relative to interactive screen 104 of multi-touch device 102. Multi-touch device 102 receives a signal from interactive object 106 as interactive object 106 interfaces with interactive screen 104, allowing multi-touch device 102 to recognize and track interactive object 106.

In an embodiment, multi-touch device 102 recognizes asymmetrical pattern of contacts 204 A-N because asymmetrical pattern of contacts 204 A-N are made of a registering material that multi-touch device 102 can be able to recognize. For example, the registering material can be a conductive material capable of being recognized by a capacitive material that makes up interactive screen 104.

As illustrated in FIG. 3, interactive object 106 can include a central stamp 302, according to an embodiment. Central stamp 302 can be made of a registering material such that multi-touch device 102 recognizes central stamp 302 when central stamp 302 touches interactive screen 104. Central stamp 302 can be coupled to a selector of interactive object 106, such that the selector only contacts interactive screen 104 when selected by the user. For example, multi-touch device 102 recognizes a change in the state when the user makes a selection by compressing interactive object 106 such that central stamp 302 touches interactive screen 104.

In an embodiment, contacts 204 A-N of interactive object 106 are in constant contact with interactive screen 104 while the user is interacting with interactive object 106. As such, multi-touch device 102 receives constant updates as to the state of interactive object 106 based on asymmetrical pattern of contacts 204 A-N. Central stamp 302 can only be in contact with interactive screen 104 when the user compresses interactive object 106, such that multi-touch device 102 recognizes a second state for interactive object 106 associated with central stamp 302.

In such an embodiment, asymmetrical pattern of contacts 204 A-N and central stamp 302 can be made of a registering material such that multi-touch device 102 recognizes when contacts 204 A-N and central stamp 302 are touching interactive screen 104. Ring 304 can surround contacts 204 A-N and central stamp 302. Ring 304 can be made of a non-registering material such that multi-touch device 102 cannot recognize ring 304 when ring 304 touches interactive screen 104. When the user wishes to interact with multi-touch device 102 using central stamp 302, the user compresses interactive object 106. Ring 304 then compresses so that central stamp 302 is also in contact with interactive screen 104 of multi-touch device 102 along with asymmetrical pattern of contacts 204 A-N. In doing so, multi-touch device 102 recognizes a second state associated with interactive object 106 in central stamp 302 coupled with the first state associated with asymmetrical pattern of contacts 204 A-N.

In an embodiment, interactive object 106 is not limited to being a separate physical object, but can be used on a user's fingertips. The user can wish to interact with multi-touch device 102 using the user's fingers rather than a physical object. In such an embodiment, interactive object 106 can still be used. Interactive object 106 can be positioned on a fingertip of an interactive glove such that the user can interact with multi-touch device 102 using the user's fingers. In another embodiment, interactive object 106 can be positioned on a ring to be worn on the user's fingers.

In an example glove-based embodiment, interactive object 106 with asymmetrical pattern of contacts 204 A-N is positioned on a first finger tip of the set of interactive gloves. A second interactive object with a second asymmetrical pattern of contacts can be positioned on a second finger tip of the set of interactive gloves. Interactive object 106 positioned on the first finger tip of the set of interactive gloves can be synchronized to a first operation to be executed by multi-touch device 102. The second interactive object positioned on the second finger tip of the set of interactive gloves can be synchronized to a second operation to be executed by multi-touch device 102.

In this manner, the user can activate two different functions operating on multi-touch device 102. For example, as the user interacts with multi-touch device 102 using interactive object 106 on first fingertip, the user can activate a function such as a paint stroke in a drawing application. As the user interacts with multi-touch device 102 using the second interactive object on the second fingertip, the user can activate a second function such as a simulated eraser that erases the paint stroke created by interactive object 106 on the first fingertip.

### System 400

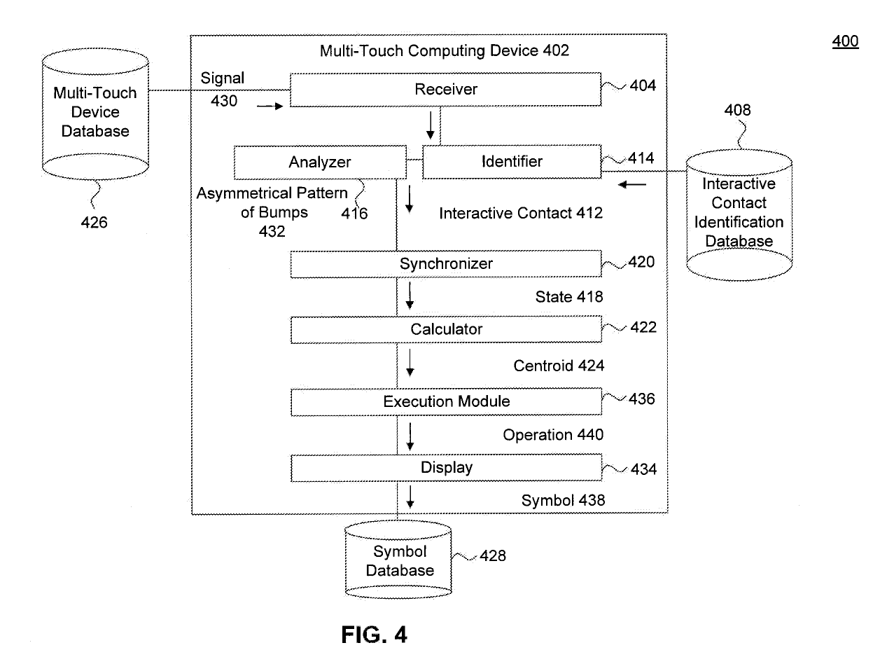

FIG. 4 is an example of a database system architecture 400 in which embodiments of the present disclosure, or portions thereof, can be implemented. System architecture 400 includes multi-touch computing device 402 coupled to multi-touch device database 426. Multi-touch computing device 402 can also be coupled to interactive object identification database 408 and symbol database 428. While the embodiment depicted in FIG. 4 shows multi-touch computing device 402 connected to multi-touch device database 426, interactive object identification database 408, and symbol database 428, it is important to note that embodiments can be used to exchange data between a variety of different types of computer-implemented data sources, systems and architectures, such as a networked cloud based architecture.

In general, multi-touch computing device 402 operates as follows. Multi-touch device database 426 supplies a signal 430 generated from an interactive object 412 interacting with multi-touch computing device 402. An asymmetrical pattern of contacts 432 on a surface of interactive object 412 interfaces with multi-touch computing device 402 and generates signal 430. Receiver 404 receives signal 430 generated as a result of the interaction.

Identifier 414 receives signal 430 from receiver 404. In an embodiment, identifier 414 determines the identity of interactive object 412 by recognizing asymmetrical pattern of contacts 432 located on interactive object 412. Identifier 414 compares asymmetrical pattern of contacts 432 with information in interactive object identification database 408 to associate asymmetrical pattern of contacts 432 with interactive object 412.

Analyzer 416 examines asymmetrical pattern of contacts 432 located on interactive object 412 to determine a state 418 of interactive object 412 as interactive object 412 interfaces with multi-touch computing device 402. For example and without limitation, state 418 includes at least one of a location of interactive object 412, a movement of interactive object 412, and an orientation of interactive object 412. Synchronizer 420 synchronizes interactive object 412 to multi-touch computing device 402 based on state 418.

In an embodiment, calculator 422 calculates a centroid 424 of asymmetrical pattern of contacts 432. Identifier 414 can identify interactive object 412 based on centroid 424. Synchronizer 420 can also synchronize interactive object 412 to multi-touch computing device 402 based on centroid 424. In another embodiment, calculator 422 calculates a coordinate based on centroid 424, and synchronizer 420 synchronizes interactive object 412 to multi-touch computing device 402 based on the coordinate.

Execution module 436 executes an operation 440 of multi-touch computing device 402. In an embodiment, the synchronization of interactive object 412 to multi-touch computing device 402 results in execution module 436 executing an operation 440 based on the synchronization.

As referred to herein, a module can be any type of processing (or computing) device having one or more processors. For example, a module can be a workstation, mobile device, computer, cluster of computers, set-top box, or other devices having at least one processor. In an embodiment, multiple modules can be implemented on the same processing device. Such a processing device can include software, firmware, hardware, or a combination thereof. Software can include one or more applications and an operating system. Hardware can include, but cannot be limited to, a processor, memory, and/or graphical user interface display.

In an embodiment, display 434 displays a symbol 438. Symbol 438 can be generated based on the synchronization of interactive object 412 to multi-touch computing device 402. Symbol 438 represents the identity of interactive object 412 as determined by identifier 414. Symbol 438 can be synchronized to interactive object 412 such that as state 418 changes for interactive object 412, symbol 438 displayed by display 434 changes accordingly. Symbols 438 representing interactive object 412 can be stored in symbol database 428.

### Method 500

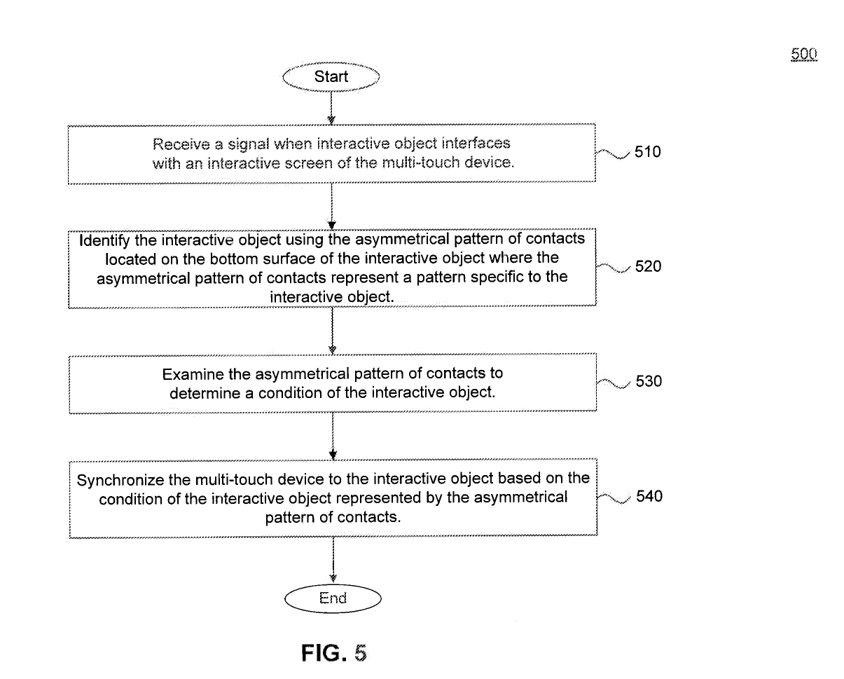

FIG. 5 is a flowchart showing an example method 500 of tracking, on a multi-touch device, at least one interactive object having an asymmetrical pattern of contacts located on a surface of the interactive object. As shown in FIG. 5, method 500 begins at stage 510, when an interactive object interfaces with an interactive screen of the multi-touch device. For example, as shown in FIG. 1, multi-touch device 102 receives a signal when interactive object 106 interfaces with interactive screen 104. Stage 510 can be performed by, for example, receiver 404.

At stage 520, the multi-touch device identifies the interactive object using the asymmetrical pattern of contacts located on the surface of the interactive object. For example, as shown in FIG. 1 and FIG. 2, multi-touch device 102 identifies interactive object 106 using asymmetrical pattern of contacts 204 A-N located on the surface of interactive object 106, where asymmetrical pattern of contacts 204 A-N represents a pattern specific to interactive object 106. Stage 520 can be performed by, for example, identifier 414.

At stage 530, the asymmetrical pattern of contacts determines a state of the interactive object. For example, as shown in FIG. 1 and FIG. 2, multi-touch device 102 examines asymmetrical pattern of contacts 204 A-N to determine a state of interactive object 106. Stage 530 can be performed by, for example, analyzer 416. Once step 530 is complete, method 500 proceeds to step 540.

At stage 540, the multi-touch device is synchronized to the interactive object. For example, as shown in FIG. 1 and FIG. 2, multi-touch device 102 can be synchronized to interactive object 106 based on the state of interactive object 106 represented by asymmetrical pattern of contacts 204 A-N. Stage 540 can be performed by, for example, synchronizer 420. When stage 540 is complete, method 500 ends.

Embodiments can work with software, hardware, and/or operating system implementations other than those described herein. Any software, hardware, and operating system implementations suitable for performing the functions described herein can be used. Embodiments are applicable to both a client and to a server or a combination of both.

### CONCLUSION

The Brief Summary and Abstract sections may set forth one or more but not all example embodiments and thus are not intended to limit the scope of the present disclosure and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described example embodiments, but should be defined only in accordance with the following claims and their equivalents.

What is claimed is:

1. A computer implemented method for providing a multi-touch device to track at least one interactive object having an asymmetrical pattern of contacts located on a surface of the interactive object, comprising:
receiving a signal when the surface of the interactive object interfaces with an interactive screen of the multi-touch device, wherein the signal is generated by the asymmetrical pattern of contacts;
identifying the interactive object using the asymmetrical pattern of contacts located on the surface of the interactive object, wherein the asymmetrical pattern of contacts represents a pattern specific to the interactive object;
examining the asymmetrical pattern of contacts to determine a state of the interactive object; and
synchronizing the multi-touch device to the interactive object based on the state of the interactive object represented by the asymmetrical pattern of contacts.

2. The method of claim 1, further comprising:
calculating a centroid for the interactive object, wherein the centroid is derived from the asymmetrical pattern of contacts of the interactive object; and
calculating a coordinate on the interactive screen based on the centroid for the interactive object.

3. The method of claim 1, wherein the interactive object comprises a central stamp surrounded by a ring that is fabricated of at least a non-registering material.

4. The method of claim 3, wherein the signal is received when the interactive object is compressed so that the central stamp touches the interactive screen of the multi-touch device.

5. The method of claim 3, wherein:
a first state specific to the interactive object is identified by examining the asymmetrical pattern of contacts that is fabricated of a registering material; and
a second state specific to the interactive object is identified by the compressing of the interactive object so that the central stamp touches the interactive screen of the multi-touch device.

6. The method of claim 1, wherein a set of interactive gloves includes at least one interactive object positioned on at least one finger tip of the set of interactive gloves.

7. The method of claim 6, wherein:
a first interactive object that is positioned on a first finger tip of the set of interactive gloves is synchronized to a first operation to be executed by the multi-touch device; and
a second interactive object that is positioned on a second finger tip of the set of interactive gloves is synchronized to a second operation to be executed by the multi-touch device.

8. The method of claim 1, wherein a motion of the interactive object on the interactive screen of the multi-touch device causes an operation to be executed by the multi-touch device.

9. The method of claim 8, wherein the interactive object is represented by a symbol that is displayed on the interactive screen of the multi-touch device.

10. The method of claim 8, wherein the motion of the interactive object comprises at least one of:
a sliding motion of the interactive object on the interactive screen of the multi-touch device; and
a twisting motion of the interactive object on the interactive screen of the multi-touch device.

11. A system for providing a multi-touch device to track at least one interactive object having an asymmetrical pattern of contacts located on a surface of the interactive object, comprising:
a receiver that receives a signal when the surface of the interactive object interfaces with an interactive screen of the multi-touch device, wherein the signal is generated by the asymmetrical pattern of contacts;
an identifier that identifies the interactive object by using the asymmetrical pattern of contacts located on the surface of the interactive object, wherein the asymmetrical pattern of contacts represents a pattern specific to the interactive object;
an examiner that examines the asymmetrical pattern of contacts to determine a state of the interactive object; and
a synchronizer that synchronizes the multi-touch device to the interactive object based on the state of the interactive object represented by the asymmetrical pattern of contacts.

12. The system of claim 11, further comprising:
a calculator that calculates a centroid for the interactive object wherein the centroid is derived from the asymmetrical pattern of contacts of the interactive object,
wherein the calculator calculates a coordinate on the interactive screen based on the centroid for the interactive object.

13. The system of claim 11, wherein the identifier identifies the interactive object that comprises a central stamp surrounded by a ring that is fabricated of at least a non-registering material.

14. The method of claim 13, wherein the receiver receives the signal when the interactive object is compressed so that the central stamp touches the interactive screen of the multi-touch device.

15. The system of claim 13, wherein the identifier identifies:
a first state specific to the interactive object by examining the asymmetrical pattern of contacts that is fabricated of a registering material; and
a second state specific to the interactive object by the compressing of the interactive object so that the central stamp touches the interactive screen of the multi-touch device.

16. The system of claim 11, wherein the identifier identifies a set of interactive gloves includes at least one interactive object positioned on at least one finger tip of the set of interactive gloves.

17. The system of claim 16, wherein a synchronizer synchronizes:
a first interactive object that is positioned on a first finger tip of the set of interactive gloves to a first operation to be executed by the multi-touch device; and
a second interactive object that is positioned on a second finger tip of the set of interactive gloves to a second operation to be executed by the multi-touch device.

18. The system of claim 11, further comprising an execution module, wherein a motion of the interactive object on the interactive screen of the multi-touch device causes the execution module to execute an operation by the multi-touch device.

19. The system of claim 18, further comprising a display that displays a symbol on the interactive screen of the multi-touch device that is a representation of the interactive object.

20. The system of claim 18, wherein the motion of the interactive object comprises of at least one of:
a sliding motion of the interactive object on the interactive screen of the multi-touch device; and
a twisting motion of the interactive object on the interactive screen of the multi-touch device.
